(19) United States
(12) Patent Application Publication
(10) Pub. No.: US 2011/0010499 A1
(43) Pub. Date: Jan. 13, 2011

(54) STORAGE SYSTEM, METHOD OF CONTROLLING STORAGE SYSTEM, AND METHOD OF CONTROLLING CONTROL APPARATUS

(75) Inventors: Nina Tsukamoto, Kawasaki (JP); Yuji Hanaoka, Kawasaki (JP); Terumasa Haneda, Kawasaki (JP); Atsushi Uchida, Kawasaki (JP); Yoko Kawano, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/831,515

(22) Filed: Jul. 7, 2010

(30) Foreign Application Priority Data
Jul. 9, 2009 (JP) 2009-163088

(51) Int. Cl. G06F 12/16; G06F 12/08

(52) U.S. Cl. 711/118; 711/E12.017; 711/162; 711/E12.103

(57) ABSTRACT

A storage system including a storage, has a first power supplier for supplying electronic power, a second power supplier for supplying electronic power when the first power supplier not supplying electronic power to the storage system, a cache memory for storing data sent out from a host, a non-volatile memory for storing data stored in the cache memory, and a controller for writing the data stored in the cache memory into the non-volatile memory when the second supplier supplying electronic power to the storage system, for stopping the writing and for deleting data stored in the non-volatile memory so until a free space volume of the non-volatile memory being not less than a volume of the data stored in the cache memory when the first supplier restoring electronic power to the storage system.

### CROSS-REFERENCE TO RELATED APPLICATION

This application is based upon and claims the benefit of priority of the prior Japanese Patent Application No. 2009-163088, filed on Jul. 9, 2009, the entire contents of which are incorporated herein by reference.

### FIELD

The present art relates to control apparatuses and the like, and, for example, it relates to processing associated with the occurrence of a power failure, which is performed by a RAID apparatus.

### BACKGROUND

In general, in each of redundant arrays of independent (inexpensive) disks (RAID) apparatuses, when a power failure occurs, cache data stored in a cache memory is backuped into a semiconductor memory device, such as a NAND type memory and Compact Flash.

In addition, a technology, in which backup operations are interrupted at the completion of transferring data stored in one of logical drives, and by triggering the completion of processing for updating of data stored in a nonvolatile memory device into the data stored in the logical drive, the processing for updating of data being in progress at the moment of the interruption, the backup operations are terminated (for example, refer to Japanese Laid-open Patent Publication No. 05-143248), a data storing method, in which, without erasing data stored in a nonvolatile memory device, it is possible to immediately commence processing for writing data into the nonvolatile memory device (for example, refer to Japanese Laid-open Patent Publication No. 2002-304320), and a technology, which enables prolonging of a period of time while the content of a cache memory is maintained subsequent to interruption of an external power supply, and reducing of a period of time necessary for restoration processes performed subsequent to recovery of the external power supply (for example, refer to Japanese Laid-open Patent Publication No. 2006-172355), are well known to those skilled in the art.

However, in the above-described existing technologies, there has been a disadvantage in that, even when the supply of electric power is recovered in process of performing power failure processing, meaningless power failure processing and power failure recovery processing still continue to be performed.

For example, even when the supply of electric power is recovered in process of saving cache data into a NAND type memory, without halting power failure processing in midstream, all pieces of cache data are saved into the NAND type memory, and then, power failure recovery processing is performed.

In this case, since electric power is supplied from the SCU to the RoC subsequent to occurrence of a power failure, and cache data stored in a cache memory remains as it is without being erased, it is unlikely to be inevitable to continuously perform the power failure processing.

Furthermore, since the power failure processing continuously performed subsequent to recovery of a power supply is unlikely to be inevitable, power failure recovery processing, such as write back processing and overall erasure processing, which is performed subsequent to completion of the power failure processing, is naturally unlikely to be inevitable.

### SUMMARY

According to an aspect of an embodiment, a storage system including a storage for storing data has a first power supplier for supplying electronic power to the storage system, a second power supplier for supplying electronic power to the storage system when the first power supplier not supplying electronic power to the storage system, a cache memory for storing data sent out from a host, a non-volatile memory for storing data stored in the cache memory, and a controller for writing the data stored in the cache memory into the non-volatile memory when the second supplier supplying electronic power to the storage system, for stopping the writing and for deleting data stored in the non-volatile memory until a free space volume of the non-volatile memory being not less than a volume of the data stored in the cache memory when the first supplier restoring electronic power to the storage system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a function block diagram illustrating a configuration of a control apparatus according to an embodiment 1 of the present art;

FIG. 2 is a function block diagram illustrating a configuration of a RAID apparatus according to an embodiment 2 of the present art;

FIG. 3 is a diagram illustrating an example of a data structure of a NAND type memory according to an embodiment 2 of the present art;

FIG. 4 is a diagram illustrating an example of a data structure of a DIMM according to an embodiment 2 of the present art;

FIG. 5 is a diagram illustrating processes performed by a RAID apparatus according to an embodiment 2 of the present art;

FIG. 6 is a flowchart illustrating processes performed by a RAID apparatus according to an embodiment 2 of the present art; and

FIG. 7 is a diagram illustrating existing technologies.

### DESCRIPTION OF EMBODIMENTS

Hereinafter, embodiments of a control apparatus, a control method and a storage system, which are disclosed in this patent application, will be described in detail with reference to drawings. In addition, it is to be noted that the present art is not limited to these embodiments.

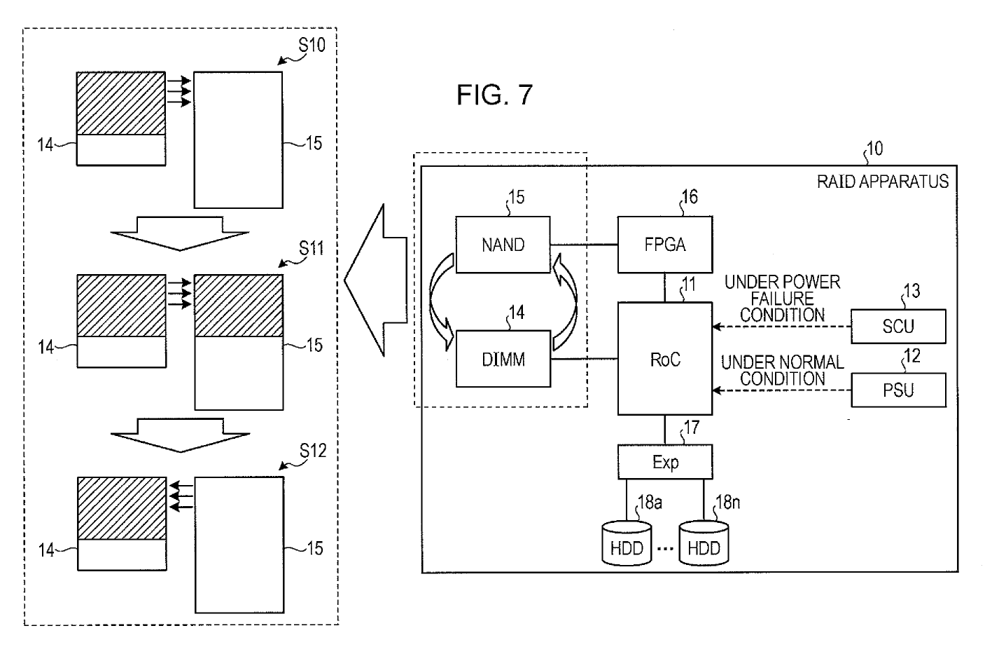

More specifically, the above-described processing will be hereinafter described with reference to a drawing. As shown in FIG. 7, under a normal condition, electric power is supplied from a power supply unit (PSU) 12 to a RAID-on-Chip (hereinafter, which will be merely called “RoC”) 11, and upon occurrence of a power failure, a power supply source for the RoC 11 is switched from the PSU 12 to a super capacitor unit (SCU) 13.

Further, by using an electric power supplied from the SCU 13, the RAID device 10 invokes a field programmable gate array (FPGA) 16 and causes the FPGA 16 to backup cache data, which is stored in a dual inline memory module (DIMM) 14, into a NAND 15.

In addition, the DIMM 14 corresponds to a cache memory included in the RAID apparatus 10. Further, the NAND 15 is the NAND type memory described above, and corresponds to a memory device used for backuping data stored in the DIMM 14.

Further, as shown in a left-hand portion of FIG. 7, firstly, processing for saving cache data (which corresponds to shaded regions shown in FIG. 7), which is temporarily stored in the DIMM 14, into the NAND 15 is commenced (in S10).

Further, when all pieces of cache data stored in the DIMM 14 have been completely saved into the NAND 15, backuping of cache data has been completed (in S11). In addition, processes performed in these steps S10 and S11 are herein called power fail processing.

Subsequently, when the power failure, which occurred on the RAID device 10, is removed and the supply of electric power is recovered, processing for reading out all pieces of saved cache data from the NAND 15 and writing the read-out all pieces of data into the DIMM 14 (i.e., write back processing subsequent to recovery of an electric power supply) is performed, and thereby, all pieces of cache data stored in the DIMM 14 are restored to the same conditions as they were before the occurrence of the power failure.

Further, subsequent to completion of the write back processing, erasure processing (overall erasure processing) for erasing all pieces of cache data stored in the NAND 15 is performed (in S12). Processing, which is performed in such a manner as described above immediately after a power failure has been removed and the supply of electric power has been recovered, will be hereinafter called power failure recovery processing.

### Embodiment 1

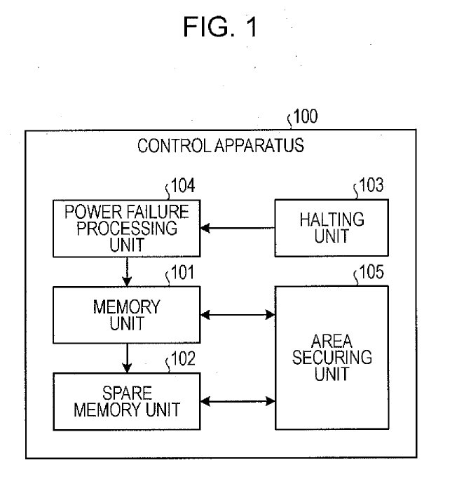

FIG. 1 is a function block diagram illustrating a configuration of a control apparatus according to an embodiment 1 of the present art. A control apparatus 100 shown in FIG. 1 is configured to, when the supply of electric power is recovered in process of saving data stored in a memory unit into a spare memory unit, secure a storage area having a storage capacity, which is determined in accordance with an amount of data stored in the memory unit, without performing overall erasure processing and write back processing.

Further, the control apparatus 100 is configured to include a memory unit 101, a spare memory unit 102, a halting unit 103, a power failure processing unit 104, and an area securing unit 105.

The memory unit 101 is a memory unit configured to temporarily store user data therein. The spare memory unit 102 is a memory unit, into which, upon occurrence of a power failure, user data, which is stored in the memory unit 101, is backuped.

The halting unit 103 is a processing unit configured to, when a power failure is removed and the supply of electric power is recovered, halt processes being performed by a power failure processing unit 104, which will be described below. The power failure processing unit 104 is a processing unit configured to, upon occurrence of a power failure, save user data, which is stored in the memory unit 101, into the spare memory unit 102.

The area securing unit 105 is a processing unit configured to, subsequent to halting processes being performed by the power failure processing unit 104, secure a saving area in the spare memory unit 102, the saving area having a storage capacity determined in accordance with an amount of user data, which is stored in the memory unit 101, and is to be saved into the saving area.

As having been described so far, the control apparatus 100 according to this embodiment 1 is configured to, when the supply of electric power is recovered in process of performing power failure processing, enable omission of meaningless power failure processing and power failure recovery processing.

### Embodiment 2

Next, an outline of a RAID apparatus, which will be shown in an embodiment 2, will be described below. A RAID apparatus 200 shown in this embodiment 2 is configured to exchange various kinds of user data and programs stored in hard disk drives (HDDs) in response to requests from an upper apparatus (for example, a host computer, which will be hereinafter called a host) by using either a method which is called “write back” or a method which is called “write through”.

Further, the RAID apparatus 200 is configured to, upon occurrence of a power failure, perform power failure processing, in which user data stored in a cache memory is saved into a NAND type memory, and upon recovery of a power supply in process of saving user data, halt the power failure processing. Furthermore, the RAID apparatus 200 is configured to, without performing write back processing and overall erasure processing on all pieces of user data stored in the cache memory, allow the RAID apparatus 200 itself to be in an “apparatus ready” condition.

Firstly, the above-mentioned “write back”, “write through” and “apparatus ready” will be hereinafter described. The “write back” is a method for delaying operations of writing data into HDDs, and performing writing of user data into HDDs using this method realizes improvement of access performance.

More specifically, firstly, when the RAID apparatus 200 receives a write command from the host, which instructs writing of user data into HDDs, upon completion of storing user data into a cache memory (which will be hereinafter called “a cache”), the RAID apparatus 200 notifies the host of the completion of writing user data into HDD. Subsequently, the user data stored in the cache is written into the HDD after having been processed so as to satisfy predetermined conditions.

Further, upon receipt of a read command from a host, which instructs reading out of user data stored in the cache, the RAID apparatus 200 does not read out requested user data from the HDD, but reads out the requested user data stored in the cache, and then, sends back the read-out user data to the host.

Therefore, allowing the RAID apparatus 200 to, upon receipt of a command from a host, which instructs reading out or writing of user data, process the command by using a cache in such a manner as described above results in realization of high-speed processing for reading out or writing of user data.

Regarding the “write through”, upon receipt of a write command from a host, which instructs writing of user data, the RAID apparatus 200 sends back a completion response to the host subsequent to completion of processes of writing user data into the HDD, and upon receipt of a read command from a host, which instructs reading out of user data, the RAID apparatus 200 sends back a completion response to the host subsequent to completion of processes of reading out user data from the HDD. Therefore, in the case where the “write through” is used, from the host side, a response from the RAID apparatus 200 is a lower-speed one, compared with a response from the RAID apparatus 200 in the case where the “write back” is used.

Regarding the “apparatus ready”, the “apparatus ready” is a condition, in which a data area, into which user data stored in a cache is to be saved, has been completely secured in a NAND type memory, and under such a condition, it is possible to prevent loss of cache data even when a power failure occurs.

Accordingly, once the RAID apparatus 200 has been in the apparatus ready condition, the RAID apparatus 200 performs exchange of user data by using the above-described “write back” method. In contrast, under the condition where a data area, into which user data stored in a cache is to be saved, has not yet been secured in a NAND type memory, the cache data is likely to be lost if a power failure occurs under such a condition, and thus, under such a condition, the RAID apparatus 200 performs reading out or writing of user data by using the “write through” method.

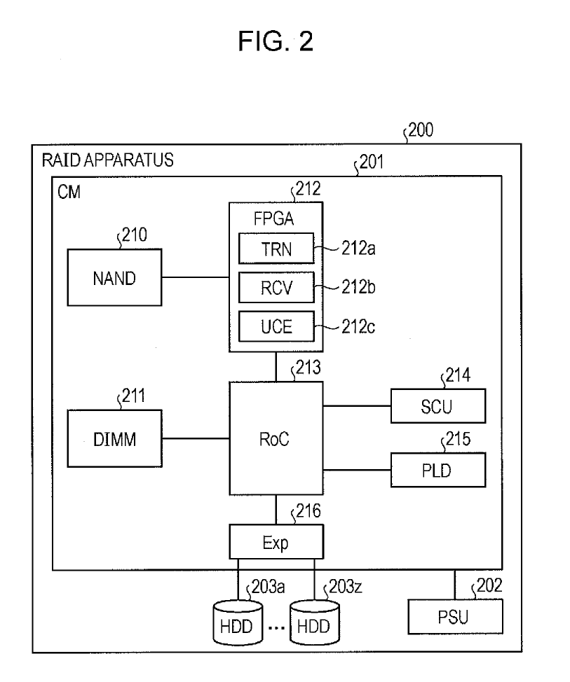

Next, a configuration of the RAID apparatus 200 shown in the embodiment 2 will be described below with reference to drawings. FIG. 2 is a function block diagram illustrating a configuration of a RAID apparatus according to this embodiment 2. The RAID apparatus 200 shown in FIG. 2 is configured to, as function units closely associated with this embodiment 2, include a controller module (CM) 201, a power supply unit (PSU) 202 and hard disk drives (HDDs) 203a to 203z.

The CM 201 is a control unit configured to manage a cache, perform control of interfaces with a host, and perform control of each of the HDDs, and includes therein a NAND 210, a dual inline memory module (DIMM) 211, a field programmable gate array (FPGA) 212, a raid-on-chip (RoC) 213, a programmable logic device (PLD) 215 and an expander (Exp) 216.

The NAND 210 is a NAND type memory module, into which, upon occurrence of a power failure on the RAID apparatus 200, user data stored in the DIMM 211, which will be hereinafter called “cache data”, is backuped.

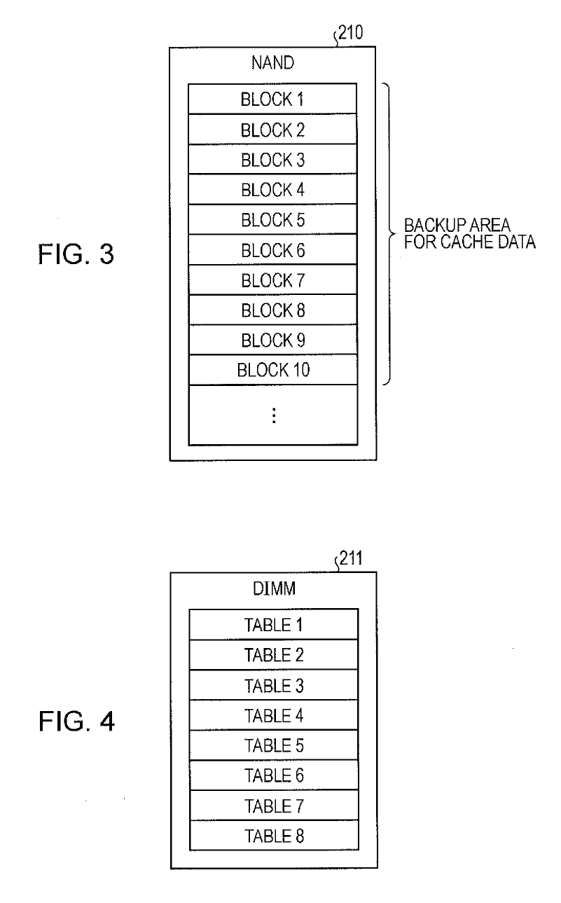

The data structure of the NAND 210 will be specifically described with reference to a drawing. FIG. 3 is a diagram illustrating an example of the data structure of a NAND type memory according to this embodiment 2. The NAND 210 shown in FIG. 3 has a data structure allowing accesses thereto for each block of data, and thus, does not allow random accesses thereto, but allows cache data to be written thereinto for each block of the cache data by using a sequential writing method.

This “block” is a data area, which allows cache data stored in the DIMM 211 to be written thereinto, and is a unit of physical segmentation of the NAND 210, and for each of these blocks of data, the cache data is written into the NAND 210.

Further each of these blocks of data includes therein a main area and a spare area, the main area being an area storing user data therein, the spare area being an area storing data therein, such as data for error check and correction (ECC) and data indicating faulty portions having been found during delivery inspections.

Further, the NAND 210 shown in FIG. 3 includes blocks 1 to 10 therein as backup areas for the DIMM 211. In addition, it is assumed that, among blocks following the block 10, there are certain blocks including therein tables, each of which indicates faulty blocks of the NAND 210, and the like, and herein, the detailed data structure of the NAND 210 is omitted from explanation.

Further, the “faulty block” is a block, into which, owing to wear and tear, the NAND 210 cannot complete writing of data within a predetermined period of time, and such a faulty block is not used for backuping of cache data. In addition, for convenience of explanation, it is assumed that the faulty blocks are not included in the blocks 1 to 10.

Next, the DIMM 211 shown in FIG. 2 will be described below. FIG. 4 is a diagram illustrating an example of a data structure of a DIMM according to this embodiment 2. The DIMM 211 is a cache memory which temporarily stores therein user data exchanged between the host and the HDDs 203a to 203z.

Further, the DIMM 211 includes a plurality of tables 1 to 8 which store the above-described user data therein as cache data. Each of the tables has a storage capacity capable of storing cache data of a size equal to 4 Mbytes. Further, this cache data includes pieces of data each having a data length of 64 Kbytes, and is managed by the RoC 213.

Further, as examples of the cache data, “read data” and “write data” can be provided. The “read data” is user data which has been already stored in one of the HDDs 203a to 203z.

Therefore, when the RAID apparatus 200 receives a request from the host for reading out user data, the RoC 213 searches the DIMM 211, and if, from the DIMM 211, the RoC 213 can acquire cache data corresponding to the request for reading, the RAID apparatus 200 outputs the acquired cache data to the host.

In contrast, if the RoC 213 cannot acquire cache data, which corresponds to the request for reading, from the DIMM 211, the RoC 213 acquires user data, which corresponds to the request for reading, from the HDD 203a or the like, and makes a copy of the acquired user data into the DIMM 211.

Regarding the “write data”, this “write data” is user data targeted for writing processes performed by the RAID apparatus 200 in accordance with a request for writing from the host, and is written into one of the HDDs 203a to 203z after having been processed so as to satisfy predetermined conditions. Particularly, this write data denotes user data which has not yet been stored in any of the HDDs 203a to 203z.

Further, the DIMM 211 shown in FIG. 4 has, for example, tables 1 to 8, in each of which pieces of read data and pieces of write data are randomly stored.

Further, in the case where a data area, into which all pieces of cache data stored in the DIMM 211 are to be saved, has been already secured in the NAND 210, the RAID apparatus 200 is allowed to perform exchanges of user data with the host by using the write back method, and under such a condition, it is obvious that the RAID apparatus 200 is in the apparatus ready condition.

Here, the explanation is returned to FIG. 2, and the FPGA 212 will be hereinafter described. The FPGA 212 is an integrated circuit controlled by prescribed programs, and includes a direct memory access (DMA) engine therein. Upon receipt of an instruction from the RoC 213, this DMA causes data to be transferred on a hardware basis.

This DMA is a method for transferring data between an apparatus and random access memory (RAM), not via a central processing unit (CPU), and further, in this embodiment 2, the FPGA 212 has a DMA engine integrated therein, which includes additional functions necessary to save and restore cache data into/from the NAND 210, the additional functions being invoked by the occurrence of a power failure.

Further, in this embodiment 2, as an example of the DMA engine, the FPGA 212 includes a TRN 212a, a RCV 212b and a UCE 212c therein, the TRN 212a being a write DMA configured to save cache data when a power failure occurs, the RCV 212b being a read DMA configured to restore cache data from saved data when the supply of electric power is recovered, the UCE 212c being a command issuing DMA configured to issue commands for instructing erasure of cache data stored in the NAND 210 and executions of various checks.

The RoC 213 is a control apparatus configured to control the whole of the CM 201, and include therein pieces of firmware configured to perform backup processes on cache data stored in the DIMM 211, perform control of interfaces with the host, and manage the DIMM 211.

The firmware of the RoC 213 is configured to, for example, when cache data is currently stored in the tables 1 to 8 of the DIMM 211, determine that, in order to backup the cache data stored in the DIMM 211, eight or more blocks of data areas are necessary.

Further, the firmware of the RoC 213 is configured to allow the RAID apparatus 200 to be in the apparatus ready condition when it has been determined that the size of blocks resulting from combination of blocks, which were not used for backuping of cache data, and blocks, which have been erased, is more than or equal to the size of data area of the DIMM 211, which currently stores the cache data therein.

The SCU 214 is a capacitor of a large amount of capacity, and is configured to, upon occurrence of a power failure on the RAID apparatus 200, supply the RoC 213 with electric power without using any batteries. In addition, since the SCU 214 supplies electric power which had been charged before the occurrence of the power failure, differing from the PSU 202, there is a limit in an amount of electric power the SCU 214 is capable of supplying.

The PLD 215 is an apparatus configured to, upon occurrence of a power failure on the RAID apparatus 200, detect the occurrence of the power failure, and notify the RoC 213 of power failure information indicating the occurrence of the power failure. Further, when the power failure is removed and the supply of electric power is recovered, the PLD 215 notifies the RoC 213 of power failure recovery information indicating the recovery of the power failure.

An expander (Exp) 216 is a processing unit configured to relay user data which is transmitted and received between the RoC 213 and the HDDs 203a to 203z.

A power supply unit (PSU) 202 is an apparatus configured to, under the condition where any power failures do not occur on the RAID apparatus 200, supply the CM 201 with electric power. Further, upon occurrence of a power failure, the PSU 202 ceases supply of electric power to the RAID apparatus 200. In addition, under such a condition, the RAID apparatus 200 is supplied with electric power discharged from the SCU 214.

The HDD 203a to HDD 203z are configured to be grouped into RAID groups, into one of which each user data is sorted in accordance with a level thereof determined from high-speed and safety characteristics.

Next, processes performed by the RAID apparatus 200 subsequent to occurrence of a power failure until resumption of the “apparatus ready” condition, as well as processes performed by the RAID apparatus 200 subsequent to reoccurrence of a power failure under the resumed “apparatus ready” condition, will be described below.

Firstly, upon occurrence of a power failure on the RAID apparatus 200, the supply of electric power from the PSU 202 to the CM 201 is halted, and simultaneously therewith, the supply of electric power from the SCU 214 to the RoC 213 is commenced. Further, the PLD 215 detects information relating to the power failure, and notifies the detected power failure information to the RoC 213.

Further, upon receipt of the power failure information, the firmware of the RoC 213 notifies the FPGA 212 of the received power failure information. Subsequently, the FPGA 212 invokes the TRN 212a. Further, the TRN 212a commences processing for backuping cache data stored in the DIMM 211 into the NAND 210.

Further, when the supply of electric power is recovered in process of performing the backup processing, the PLD 215 notifies the FPGA 212 of power failure recovery information, and the FPGA 212 halts the backup processing being performed by the TRN 212a in midstream.

Moreover, without writing back all pieces of saved cache data and performing overall erasure, when the firmware of the RoC 213 determines that data areas, into which cache data stored in the DIMM 211 is to be saved, have been completely secured in the NAND 210, the firmware of the RoC 213 allows the RAID apparatus 200 to be in the “apparatus ready” condition.

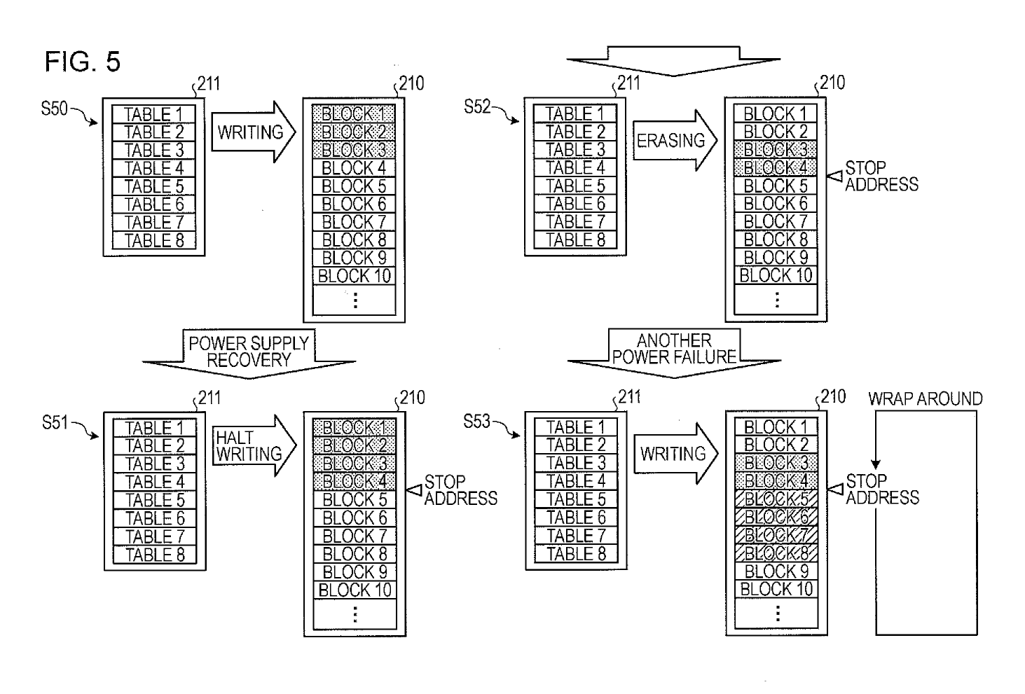

The above-described processes will be specifically described below with reference to drawings. FIG. 5 is a diagram illustrating processes performed by a RAID apparatus according to this embodiment 2. The DIMM 211 shown in FIG. 5 corresponds to the DIMM 211 shown in FIG. 3, and it is assumed that each of the tables 1 to 8 stores cache data therein.

Moreover, the NAND 210 shown in FIG. 5 corresponds to the NAND 210 shown in FIG. 3, and it is assumed that each of the blocks 1 to 10 is not a faulty block, and an address of the block 10 is a physical last address.

Further, in order to allow the RAID apparatus 200 to be in the apparatus ready condition, it is necessary merely to fulfill a condition, in which a data area, into which all pieces of cache data stored in the DIMM 211 is to be saved, has been secured in the NAND 210, and in this embodiment 2, it is assumed that it is necessary merely to fulfill a condition, in which all the blocks 1 to 8 have been secured in the NAND 211 as a data area for backuping cache data.

Firstly, upon occurrence of a power failure, the TRN 212a commences backuping of cache data stored in the DIMM 211 into the NAND 210 in an order of table numbers (in S50). In this step S50, it is assumed that pieces of cache data stored in the tables 1 to 3 are written into the blocks 1 to 3.

Subsequently, in the case where the supply of electric power is recovered at the timing when pieces of cache data stored in the table 4 have been completely written into the block 4, the TRN 212a halts processes of backuping cache data into the NAND 210. Further, the firmware of the RoC 213 retains a NAND address (for example, an address 4), which identifies the block 4 (in S51).

Further, the UCE 212c commences erasure of cache data stored in the block 1 of the NAND 210. Further, at the timing when all pieces of cache data stored in the blocks 1 and 2 have been completely erased, the firmware of the RoC 213 determines that the condition, in which a data area for backuping all pieces of cache data stored in the DIMM 211 is secured in the NAND 210, has been fulfilled, and allows the RAID apparatus 200 to be in the apparatus ready condition (in S52).

The reason of this determination is such that it is necessary merely to fulfill a condition, in which, pieces of cache data are currently stored in the tables 1 to 8 of the DIMM 211, and as a backup area into which these pieces of cache data are to be backuped, the total size of eight blocks is to be secured in the NAND 210, which is a flash memory.

Therefore, in step S52, once all pieces of cache data saved in the blocks 1 and 2 have been completely erased, a backup area corresponding to the area in which all pieces of cache data are stored becomes an area consisting of eight blocks resulting from combination of the erased blocks 1 and 2 and the blocks 5 to 10, which were not used in the backuping processes performed in step S50, and thus, the firmware of the RoC 213 determines that a backup area for all the pieces of cache data has been sufficiently secured, and allows the RAID apparatus 200 to be in the apparatus ready condition.

Further, when a power failure occurs again on the RAID apparatus 200, the RoC 213 instructs the FPGA 212 to refer to the address 4, which was retained in step 51, and again, commence processes of backuping cache data into blocks starting from the block 5 corresponding to an address 5.

Further, the TRN 212a writes cache data stored in the table 1 into the block 5, and then, writes cache data stored in the table 2 into the block 6. Subsequently, the TRN 212a writes cache data stored in the tables 3, 4 and 5 into the block 7, 8 and 9, respectively.

Further, after the TRN 212a has written cache data stored in the table 6 into the block 6, a block targeted for backuping of cache data is moved to the block 1, and then, the TRN 212a writes cache data stored in the table 7 into the block 1 (in S53).

The above-described method, in which cache data is written into an area starting from an address which is not a first address of the NAND 210 but is a stop address of backuping processes, that is, an address corresponding to a block following a block, which is a last block, for which backup processes were previously performed, and subsequent to writing of cache data into an area whose address is a physical last address of the NAND 210, an area targeted for writing of cache data is moved to an area whose address is a first address of the NAND 210, and then, relevant cache data is written thereinto, is called wrap around processing.

As described above, when, in process of performing power fail processing, the supply of electric power is recovered, the RAID apparatus 200 halts processes of saving cache data in midstream. Furthermore, without performing processes of writing back of saved data, which are generally performed in existing methods when the supply of electric power is recovered, the RAID apparatus 200 performs partial erasure of the NAND 210.

Further, if the size of a data area resulting from combination of a data area, for which partial erasure processes has been completed, and a data area, which was not used during performing power failure processing, is more than or equal to the size of a data area of the DIMM 211, in which cache data is currently stored, the RoC 213 determines that a backup area has been completely secured, and then, allows the RAID apparatus 200 to be in the apparatus ready condition.

Further, when a power failure occurs again, backup processes on cache data is performed by using the wrap around processing.

In addition, with respect to a condition allowing the RAID apparatus 200 to be in the apparatus ready condition, an example, in which the size of a data area of the NAND 210, into which cache data stored in the DIMM 211 is to be saved, is more than or equal to the size of a data area of the DIMM 211, in which cache data is currently stored, has been described so far; however, in the case where the size of a data area of the NAND 211, into which cache data stored in the DIMM 211 is to be saved, is more than or equal to the size of the whole of a physical data area of the DIMM 211, in which cache data is to be stored, the RAID apparatus 200 may be allowed to be in the apparatus ready condition, or in the case where the size of a data area of the NAND 210, into which cache data stored in the DIMM 211 is to be saved, is more than or equal to a certain size of a data area of the DIMM 211, which is determined in advance by administrators of the RAID apparatus 200, the RAID apparatus 200 may be allowed to be in the apparatus ready condition.

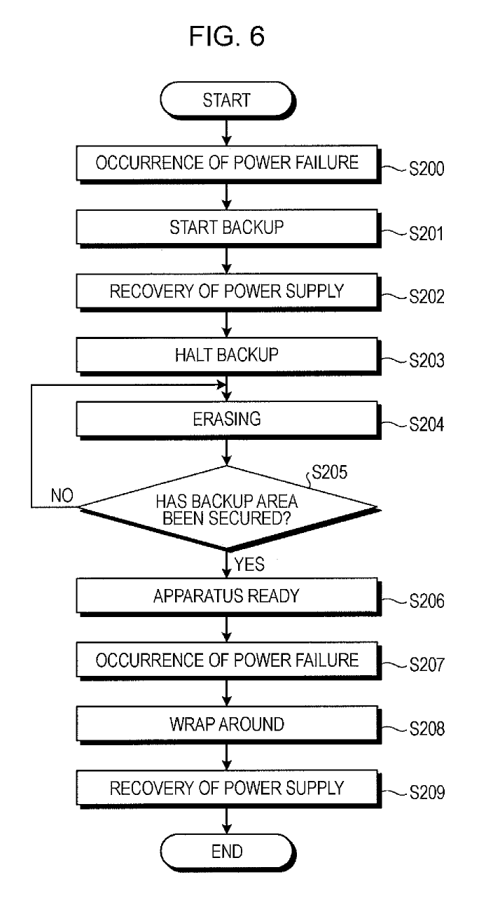

Next, processes performed by the RAID apparatus 200 in this embodiment 2 will be described below. FIG. 6 is a flowchart illustrating processes performed by a RAID apparatus according to this embodiment 2. Firstly, a power failure occurs on the RAID apparatus 200 (in S200).

Further, cache data stored in the DIMM 211 is backuped into the NAND 210 (in S201). Subsequently, in the case where the supply of electric power is recovered in process of performing backup processing (in S202), the backup processing is halted (in S203).

Further, the FPGA 212 erases cache data having been written into the NAND 210 (in S204). Further, if the size of a data area of the NAND 210, resulting from combination of a data area which was erased in processes performed in step S204, and a data area which was not used in processes of backuping cache data, which were performed in step S201, is more than or equal to the size of a data area of the DIMM 211, in which cache data is currently stored, the FPGA 212 determines that a data area for backuping cache data has been completely secured (in S205, Yes), and allows the RAID apparatus 200 to be in the apparatus ready condition (in S206).

Further, if a power failure occurs again on the RAID apparatus 200 (in S207), the wrap around processing is performed (in S208). Subsequently, when the supply of electric power is recovered (in S209), the RAID apparatus 200 is allowed to transit to a normal operation condition.

In addition, in step S204, if the size of a data area of the NAND 210, resulting from combination of a data area which was erased in step S204, and a data area which was not used in processes of backuping cache data is less than the size of a data area of the NAND 210, into which cache data is to be saved (in S205, No), the process flow returns to step S204.

According to this flowchart, in the case where, in process of performing power failure processing, the supply of electric power is recovered, by causing processes of saving cache data to halt in midstream, it is possible to omit meaningless power failure processing. Furthermore, by partially performing erasure processing on saved cache data without writing back saved cache data into the DIMM 211, it is possible to omit meaningless power failure recovery processing.

Further, if the size of a data area of the NAND 211, into which cache data is to be saved, is less than the size of a data area of the DIMM 211, in which cache data is currently stored, the firmware of the RoC 213 does not allow the RAID apparatus 200 to be in the apparatus ready condition, since the cache data is likely to be lost if a power failure occurs again under such a condition.

Therefore, if the size of a data area of the NAND 210, resulting from combination of a data area which was erased, and a data area which was not used in processes of backuping cache data, is more than or equal to the size of a data area to be secured for backuping cache data, the firmware of the RoC 213 determines that a data area for backuping cache data has been completely secured, and allows the RAID apparatus 200 to be in the apparatus ready condition.

Accordingly, without writing back saved cache data and performing overall erasure processing when the supply of electric power is recovered, it is possible to allow the RAID apparatus 200 to be in the apparatus ready condition, and as a result, this method enables reduction of processing time necessary for the RAID apparatus 200 to be allowed to be in the apparatus ready condition.

As having been described so far, in the RAID apparatus 200 according to this embodiment 2, in the case where, in process of performing power failure processing, the supply of electric power is recovered, it is possible to omit meaningless power failure processing and power failure recovery processing.

In a control apparatus disclosed in this patent application, in the case where the supply of electric power is recovered in process of performing power failure processing, it is possible to omit meaningless power failure processing and power failure recovery processing.

As mentioned above, the present art has been specifically described for better understanding of the embodiments thereof and the above description does not limit other aspects of the art. Therefore, the present art can be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage system including a storage for storing data comprising:
a first power supplier for supplying electronic power to the storage system;
a second power supplier for supplying electronic power to the storage system when the first power supplier not supplying electronic power to the storage system;
a cache memory for storing data sent out from a host;
a non-volatile memory for storing data stored in the cache memory; and
a controller for writing the data stored in the cache memory into the non-volatile memory when the second supplier supplying electronic power to the storage system, for stopping the writing and for deleting data stored in the non-volatile memory until a free space volume of the non-volatile memory being not less than a volume of the data stored in the cache memory when the first supplier restoring electronic power to the storage system.

2. The storage system of claim 1, wherein the controller determines that the free space volume of the non-volatile memory is not less than a volume of the data stored in the cache memory on the basis of the deleted volume of the non-volatile memory and a volume of the non-volatile memory which is not used for backup of cache data.

3. The storage system of claim 1, wherein the controller retains an address indicating where the data stored in the cache memory has written into the non-volatile memory.

4. The storage system of claim 3, wherein the controller writes the data stored in the cache memory into the non-volatile memory in accordance to the address.

5. A method of controlling a storage system including a storage for storing data; the method comprising:
supplying electronic power to the storage system by a first power supplier, and a second power supplier when the first power supplier not supplying electronic power to the storage system;
storing data stored in the storage into a cache memory;
writing the data stored in the cache memory into a non-volatile memory when the second supplier supplying electronic power to the storage system;
stopping the writing; and
deleting data stored in the non-volatile memory so that a free space volume of the non-volatile memory is not less than a volume of the data stored in the cache memory when writing the data stored in the cache memory into the non-volatile memory and restoring electronic power to the storage system by the first supplier.

6. The method of claim 5, further comprising determining that the free space volume of the non-volatile memory is not less than a volume of the data stored in the cache memory on the basis of the deleted volume of the non-volatile memory and a volume of the non-volatile memory which is not used for backup of cache data.

7. The method of claim 5, further comprising retaining an address indicating where the data stored in the cache memory has written into the non-volatile memory.

8. The method of claim 7, wherein the writing writes the data stored in the cache memory into the non-volatile memory in accordance to the address.

9. A method of controlling a control apparatus being connectable to a storage for storing data, a cache memory for storing data stored in the storage, and a non-volatile memory for storing data stored in the cache memory, the method comprising:
writing the data stored in the cache memory into the non-volatile memory when a power failure being occurred;
stopping the writing; and
deleting data stored in the non-volatile memory so that a free space volume of the non-volatile memory is not less than a volume of the data stored in the cache memory when writing the data stored in the cache memory into the non-volatile memory and a supply of electric power being recovered.

10. The method of claim 9, further comprising determining that the free space volume of the non-volatile memory is not less than a volume of the data stored in the cache memory on the basis of the deleted volume of the non-volatile memory and a volume of the non-volatile memory which is not used for backup of cache data.

11. The method of claim 9, further comprising retaining an address indicating where the data stored in the cache memory has written into the non-volatile memory.

12. The method of claim 11, wherein the writing writes the data stored in the cache memory into the non-volatile memory in accordance to the address.
